(19) United States
(12) Patent Application Publication
(10) Pub. No.: US 2019/0331245 A1
(43) Pub. Date: Oct. 31, 2019

(54) WELL SERVICE PUMP SYSTEM FLUID END

(71) Applicant: AMERIFORGE GROUP INC., Houston, TX (US)

(72) Inventors: Tom GABLE, Houston, TX (US); Garrett Smith, Houston, TX (US)

(21) Appl. No.: 16/395,959

(22) Filed: Apr. 26, 2019

Related U.S. Application Data
(60) Provisional application No. 62/664,077, filed on Apr. 27, 2018.

(51) Int. Cl. F16K 27/02; F16L 15/00

(52) U.S. Cl. CPC F16K 27/0209; E21B 41/00; F16L 15/006

(57) ABSTRACT

A pump fluid end assembly having removable, modular valve blocks that include check valves such that the check valves can be more easily and quickly accessed, replaced, or repaired at a well site by removing the modular valve blocks from a fluid end of the pump fluid end assembly and from an inlet connection and an outlet connection of the pump fluid end assembly.

### CROSS-REFERENCE TO RELATED APPLICATIONS

This application claims priority to U.S. Provisional Application No. 62/664,077, filed Apr. 27, 2018, the entire contents of which application are specifically incorporated by reference herein without disclaimer.

### FIELD OF INVENTION

The present invention relates generally to pumping assemblies used for well servicing applications and, more particularly, concerns repair or replacement of fluid end components.

### BACKGROUND

Oil and gas wells require services such as fracturing, acidizing, cementing, sand control, well control and circulation operations. All of these services require pumps for pumping fluid down the well. Such pumps are generally included in a pumping system that includes components such as hydraulic fluid reservoirs, an engine/motor, pumps, pump drives, a pump assembly (including hydraulic ram cylinders coupled to working fluid end cylinders), and a fluid end assembly. A fluid end assembly generally includes a plurality of fluid ends (i.e., housings) that are coupled to the pump assembly and to manifolds such that working fluid can be received in and pumped out of fluid end assembly through the fluid ends. Such fluid ends generally include check valves that control the flow of working fluid between the fluid ends and manifolds.

### SUMMARY

Check valves and other parts of a valve assembly that are used for receiving and discharging working fluid from a pumping system are subject to use fatigue and may need to be replaced or repaired. For example, the check valve may fail under high, repeated pumping pressures of fluid passing through the check valve. Accessing, replacing, and repairing such valve assembly components can be difficult and time-consuming, especially if such components are disposed within a small orifice in a fluid end. Such an operation may require removing the entire fluid end (e.g., disconnecting manifold and other pumping system components) and/or using special tools. Because of these problems, valve assembly components are generally replaced off the well site where the proper tools and procedures can be employed. Accordingly, accessing, replacing, and repairing valve assembly components may require shutting down a well pumping operation for an relative large amount of time.

The present apparatuses and methods addresses these issues by providing a fluid end assembly with check valves disposed within removable, modular blocks that can be quickly and easily replaced without the need to handle check valve components or remove the fluid end from the pumping system. With the present apparatuses and methods, valve assembly components, such as check valves, can be accessed, replaced, and/or repaired at a well site such that a pumping operation may not need to be shut down or may only need to be shut down for a relatively short period of time. Other advantages and uses of the present apparatuses and methods will be apparent to a person of ordinary skill in the art upon considering the remainder of this disclosure.

Some embodiments of the present apparatuses and methods disclose a pump fluid end assembly comprising: a housing defining a pump port configured to be coupled to a pump, an inlet lumen in fluid communication with the pump port, and an outlet lumen in fluid communication with the pump port; an inlet check valve disposed in the inlet lumen and configured to permit fluid to flow into the housing through the inlet lumen, and to prevent fluid from flowing out of the housing through the inlet lumen; an outlet check valve disposed in the outlet lumen and configured to permit fluid to flow out of the housing through the outlet lumen, and to prevent fluid from flowing into the housing through the outlet lumen; an inlet block defining an inlet and removably coupled to the housing such that: the inlet is in fluid communication with the inlet lumen of the housing; and removal of the inlet block from the housing permits removal of the inlet check valve; and an outlet block defining an outlet and removably coupled to the housing such that: the outlet is in fluid communication with the outlet lumen of the housing; and removal of the outlet block from the housing permits removal of the outlet check valve.

The inlet block and outlet block can be coupled to the housing with a threaded or bolted connection (or otherwise) and held in place with a fastener, such as a nut that can be threaded onto the inlet/outlet block against the housing. The inlet block and/or outlet block can also include a flange configured to be coupled to a fitting with a plurality of bolts (e.g., through a plurality of aligned bolt holes in the flange and fitting). Alternatively, the inlet block and/or outlet block can be coupled to a hammer union fitting via threads and held in place with a fastener, such as a nut that can be threaded onto the fitting against the inlet block and/or outlet block. The fitting can include a fitting lumen that, when coupled to the inlet block or outlet block, is in fluid communication with the inlet or outlet, respectfully. Such a hammer union fitting can include a distal end with a hammer union connection (i.e., a connection created without rotation of either of the coupled elements).

In some embodiments, the inlet check valve can include a valve seat coupled to the inlet block. The valve seat can have a valve seat shoulder and a valve seat lumen configured to be in fluid communication with the inlet lumen of the housing when the inlet check valve is in an open configuration (i.e., permitting fluid to flow through the inlet). The inlet check valve can further include a valve having a valve shoulder and an end spaced apart from the valve shoulder. The valve can prevent fluid communication between the valve seat lumen and the inlet lumen of the housing when the inlet check valve is in a closed configuration (i.e., preventing fluid from flowing through the inlet). The closed configuration can include mating the valve shoulder with the valve seat shoulder. The inlet check valve can further include a biasing spring having a first end and a second end spaced apart from the first end. The first end of the biasing spring can be coupled to the end of the valve to bias the inlet check valve into the closed configuration. The inlet check valve can also include a retainer plate have a first end and a plurality of radially-extending arms spaced apart from the first end of the retainer plate. The plurality of radially-extending arms can each have a shoulder at their radial ends. The first end of retainer plate can be coupled to the second end of the biasing spring. In this configuration, the biasing spring can bias the shoulders of the radial ends of the plurality of radially-extending arms into mating contact with an inner shoulder of the inlet block or an inner shoulder of the housing. The radially-extending arms of the retainer plate can be spaced apart from one another such that the retainer plate does not block fluid communication between the inlet and the inlet lumen of the housing.

In some embodiments, the outlet check valve can include a valve seat coupled to the outlet block. The valve seat can have a valve seat shoulder and a valve seat lumen configured to be in fluid communication with the outlet lumen of the housing. The outlet check valve can further include a valve having a valve shoulder and an end spaced apart from the valve shoulder. The valve can prevent fluid flow through the outlet check valve when the outlet check valve is in a closed configuration (i.e., preventing fluid from flowing through the inlet). The closed configuration can include mating the valve shoulder with the valve seat shoulder. The outlet check valve can further include a biasing spring having a first end and a second end spaced apart from the first end. The first end of the biasing spring can be coupled to the end of the valve to bias the outlet check valve into the closed configuration. The outlet check valve can also include a retainer plate have a first end and a plurality of radially-extending arms spaced apart from the first end of the retainer plate. The plurality of radially-extending arms can each have a shoulder at their radial ends. The first end of retainer plate can be coupled to the second end of the biasing spring. In this configuration, the biasing spring can bias the shoulders of the radial ends of the plurality of radially-extending arms into mating contact with an inner shoulder of the outlet block. The radially-extending arms of the retainer plate can be spaced apart from one another such that the retainer plate does not prevent fluid flow through the outlet.

In some embodiments, the fluid end assembly further includes a working fluid end cylinder coupled to the housing such that an outlet of the working fluid end cylinder is in fluid communication with the pump port. The working fluid end cylinder can be coupled to the housing with a threaded or bolted connection (or otherwise) and held in place with a fastener, such as a nut that can be threaded onto working fluid end cylinder against the housing. The working fluid end cylinder can include a plunger rod for driving the working fluid through the housing and the plunger rod can extend into the housing during such an operation.

Some embodiments of the present apparatuses and methods disclose a method of maintaining operation of a pump comprising: positioning a pump assembly at a location where a pumping operation is to be performed, the pump assembly including a pump, a fluid end, and a check valve; and replacing the check valve while the fluid end is connected to the pump. One method of replacing the check valve in such a configuration is for the check valve to be positioned within a valve block that is coupled to the fluid end such that check valve can be removed from the fluid end by removing the valve block from the fluid end. Then, the check valve can be replaced in the valve block with a new check valve and the valve block can be recoupled to the fluid end. Alternatively, the entire valve block can be replaced in the fluid end with another valve block having a different check valve positioned within it. In some embodiments, the method can further include positioning and/or coupling any of the above described features of the pump fluid end assembly in the manners described.

Some embodiments of the present apparatuses and methods include an assembly comprising: a housing defining a fluid chamber; and a valve block defining a lumen and removably coupled to the housing such that the lumen is in fluid communication with the fluid chamber of the housing and removal of the valve block from the housing permits removal of a check valve, where the check valve is configured to permit fluid flow into or out of the fluid chamber of the housing when in an open configuration and to prevent fluid flow into or out of the fluid chamber of the housing when in a closed configuration. In such an assembly, the valve block can be coupled to the housing with a threaded or bolted connection (or otherwise) and held in place with a fastener, such as a nut that can be threaded onto the valve block against the housing. The valve block can further include a flange that can be coupled to a fitting with a plurality of bolts (e.g., through a plurality of aligned bolt holes in the flange and fitting). Alternatively, the valve block can be coupled to a hammer union fitting with by threads and optionally held in place with a fastener, such as a nut that can be threaded onto the fitting against the valve block. The fitting can include a fitting lumen that, when coupled to the valve block, is in fluid communication with the valve block. This fitting can additionally or alternatively be threaded onto the valve block. Such a hammer union fitting can include a distal end with a hammer union connection (i.e., a connection created without rotation of either of the coupled elements).

The check valve of the assembly can include a valve seat coupled to the valve block. The valve seat can have a valve seat shoulder and a valve seat lumen configured to be in fluid communication with the fluid chamber of the housing. The check valve can further include a valve having a valve shoulder and an end spaced apart from the valve shoulder. The valve can prevent fluid flow through the check valve when the check valve is in the closed configuration (i.e., preventing fluid flow through the valve block). The closed configuration can include mating the valve shoulder with the valve seat shoulder. The check valve can further include a biasing spring having a first end and a second end spaced apart from the first end. The first end of the biasing spring can be coupled to the end of the valve to bias the check valve into the closed configuration. The check valve can further include a retainer plate have a first end and a plurality of radially-extending arms spaced apart from the end of the retainer plate. The plurality of radially-extending arms can each have a shoulder at their radial ends. The first end of retainer plate can be coupled to the second end of the biasing spring such that the biasing spring biases the shoulders of the radial ends of the plurality of radially-extending arms into mating contact with an inner shoulder of the valve block or an inner shoulder of the housing. The radially-extending arms of the retainer plate can be spaced apart from one another such the retainer plate does not prevent fluid flow through the valve block.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a perspective view of an example of a well service pump system.

FIG. 2 is an enlarged, cross-sectional side view of a portion of the well service pump system of FIG. 1 along a line extending length-wise across hydraulic ram cylinder 1602.

FIG. 3 is an enlarged, cross-sectional side view of a portion of the well service pump system of FIG. 1, showing some details of a fluid end assembly 1900.

FIG. 4 is an exploded perspective view of the inlet check valve assembly of the fluid end assembly 1900 of FIG. 3.

FIG. 4A is an enlarged perspective view of the inlet block of fluid end assembly 1900 of FIG. 3.

FIGS. 4B to 4E are an enlarged perspective views of the valve seat, valve, biased spring, and retainer member, respectively, of the inlet check valve of the fluid end assembly 1900 of FIG. 3.

FIG. 5 is a cross-sectional perspective view of the details of fluid end assembly 1900 shown in FIG. 3.

FIG. 6 is a cross-sectional perspective view of an embodiment of a fluid end assembly.

### DESCRIPTION OF ILLUSTRATIVE EMBODIMENTS

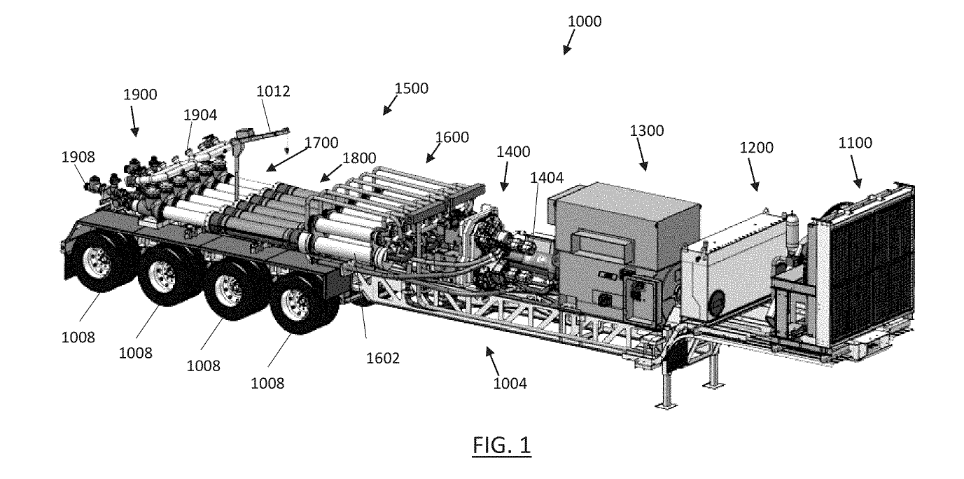

Referring now to FIG. 1, shown therein and designated by the reference numeral 1000 is an embodiment of a well service pump system of the present apparatuses and methods. Pump system 1000 can be used to perform fracturing, acidizing, cementing, sand control, well control and/or circulation operations by pumping working fluids into a well. Many of the components of pump system 1000 are described in greater detail in U.S. Patent Application Publication No. US 2015/0192117, and will only be described briefly herein.

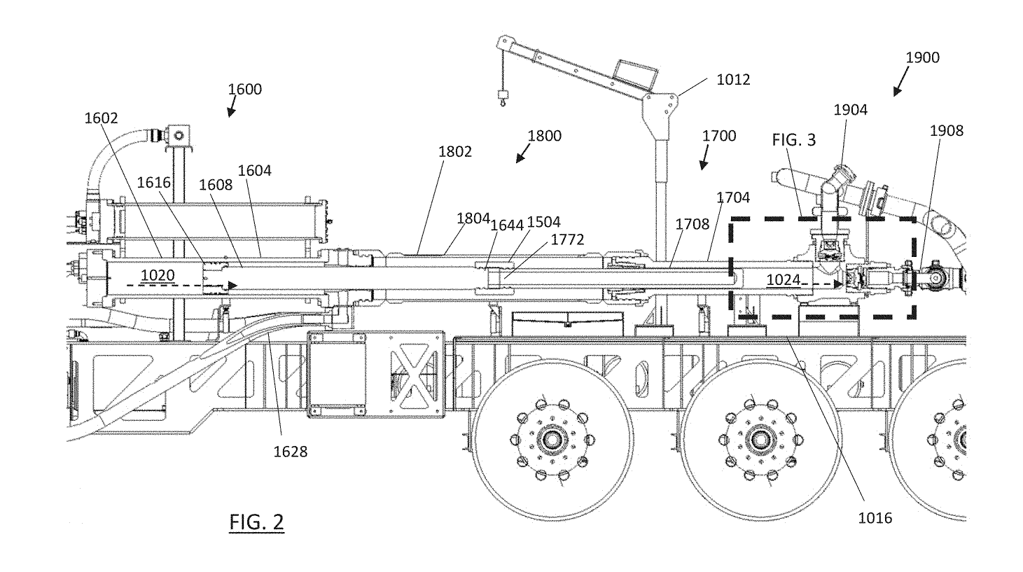

Pump system 1000 is mounted on trailer 1004 having wheels 1008 such that pump system 1000 can be transported to and from a site, such as a well site, to perform a pumping operation. Pump system 1000 includes a number of components, including cooler 1100, reservoir 1200, motor 1300, pumps 1400, and a series of pump assemblies 1500 (six shown). Cooler 1100 can remove heat from one or more components of pump system 1000, such as from motor 1300 and/or reservoir 1200, during a pumping operation. Reservoir 1200 can hold hydraulic fluid that is used to actuate pump assemblies 1500. Motor 1300 can include one or more sources of mechanical energy, such as a diesel engine, gasoline engine, and/or an electric motor, and is used to power pumps 1400 via a pump drive 1404. For example, each pump 1400 can be powered to drive hydraulic fluid to a hydraulic ram cylinder, such as hydraulic ram cylinder 1602, to actuate a plunger rod, such as plunger rod 1708, as described herein. Engine/motor 1300 is coupled to a pump 1400 via a pump drive. Pump assemblies 1500 include hydraulic ram cylinder assemblies 1600, working fluid end cylinder assemblies 1700, and structure joints 1800. These pump assembly components will be described in more detail with reference to FIG. 2. Pump assemblies 1500 are connected to fluid end assembly 1900 that facilitates delivery of working fluid to (via inlet connection 1904) and from (via discharge manifold 1908) working fluid end cylinder assemblies 1700. Pump system 1000 also includes other components, such as crane 1012 for handling pump system components like components of fluid end assembly 1900.

Referring now to FIG. 2, hydraulic ram cylinder assembly 1600 includes a hydraulic ram cylinder 1602 having a ram cylinder housing 1604. Pumps 1400 pump hydraulic fluid into ram cylinder housing 1604 to drive ram piston 1616 disposed within ram cylinder housing 1604 in direction 1020. Ram piston 1616 can include sealing elements that prevent hydraulic fluid from passing by ram piston 1616 within ram cylinder housing 1604 such that substantially all of the force provided by the hydraulic fluid is transmitted into ram piston 1616. Ram piston 1616 is coupled to piston rod 1608 which is driven with piston head 1616 in direction 1020. Piston rod 1608 includes a distal end 1644 that protrudes from the distal end of ram cylinder housing 1608 and is coupled to proximal end 1772 of plunger rod 1708 of working fluid end cylinder assembly 1700. Plunger rod 1708 protrudes from the proximal end of end cylinder housing 1704 of working fluid end cylinder 1702. Distal end 1644 of piston rod 1608 can be coupled to proximal end 1772 of plunger rod 1708 by, for example, using a bracket 1504. Bracket 1504 can be a single unitary piece or made from multiple pieces and can be threaded, bolted, welded, or otherwise coupled to exterior surfaces of the piston rod 1608 and plunger rod 1708. Bracket 1504 has a maximum radial diameter less than the inner radial diameter of joint housing 1802 of structural joint 1804, such that piston rod 1608, bracket 1504, and plunger rod 1708 can reciprocate within joint housing 1804 without contacting joint housing 1804.

When driven by ram piston 1616, piston rod 1608 drives plunger rod 1708 further into end cylinder housing 1704, which decreases the fluid volume in end cylinder housing lumen 1788 of end cylinder housing 1704, driving working fluid located in end cylinder housing lumen 1788 through fluid end block assembly 1910 and discharge manifold 1908 of fluid end assembly 1900. The fluid discharged may be driven, for example, into a well to perform a well operation. After driving working fluid through discharge manifold 1908, plunger rod 1708 can be driven in direction 1024 by forcing hydraulic fluid through return line 1628 of hydraulic ram cylinder assembly 1600 into the annulus between piston rod 1608 and ram cylinder housing 1604 to drive ram piston 1616 in direction 1024. Working fluid can then be supplied (e.g., through internal suction and/or external positive pressure) into end fluid cylinder 1704 (and fluid end 1912) through inlet connection 1904 in anticipation of a subsequent piston stroke.

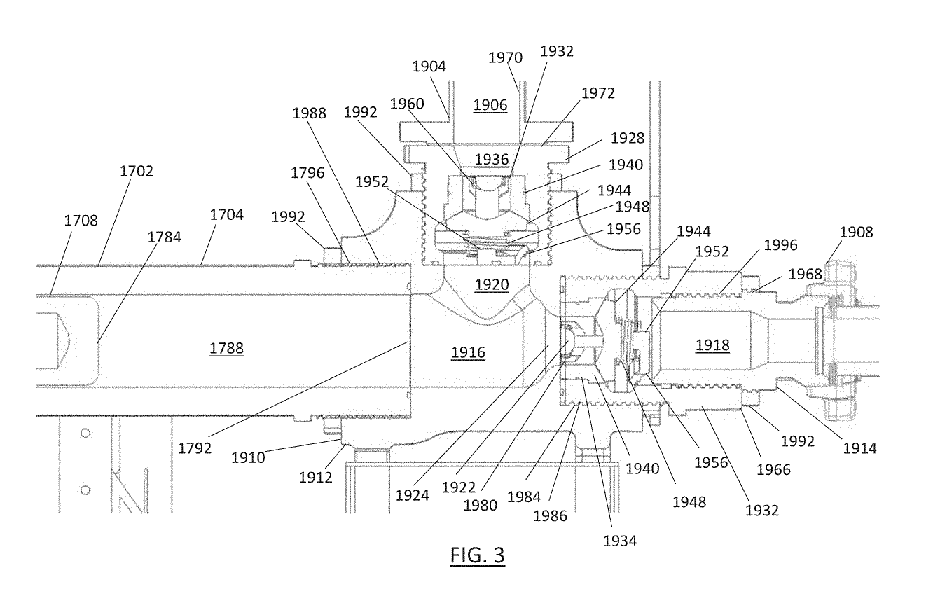

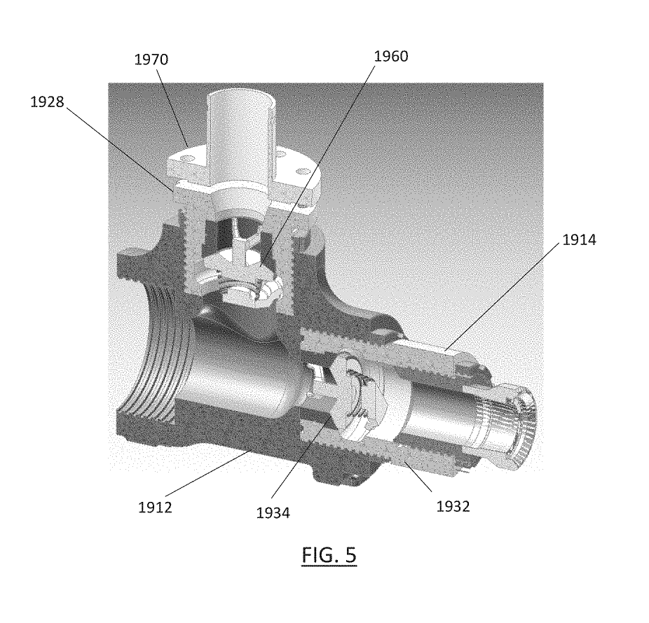

The structure and operation of fluid end block assembly 1910 will now be described in more detail with reference to FIGS. 3 to 5E. Fluid end block assembly 1910 includes a fluid end/housing 1912 having a fluid chamber 1916, inlet lumen 1920, outlet lumen 1924, inlet block 1960, and outlet block 1932. Fluid end 1912 can also include other inlets and outlets as desired. For example, fluid end 1912 could include more than one inlet lumen or outlet lumen. Fluid end 1912 defines a pump port that is coupled to a pump. In particular, a distal end 1792 of end cylinder housing 1704 of working fluid end cylinder 1702 is coupled directly to end 1902 of fluid end 1912 such that end cylinder housing lumen 1788 is in fluid communication with fluid chamber 1916. In this configuration, end 1784 of plunger rod 1708 of working fluid end cylinder 1702 can extend into fluid chamber 1916 to force working fluid disposed in fluid chamber 1916 through outlet lumen 1924. Distal end 1792 of end cylinder housing 1704 can be coupled to fluid end 1912 in various ways, including by mating threads 1796 on an exterior surface of end cylinder housing 1704 with corresponding threads 1988 of fluid end 1912. This coupling can be secured by threading a fastener, such as a nut 1992 onto a portion of threads 1796 (or other threads on the exterior surface of end cylinder housing 1704) such that nut 1992 presses against fluid end 1912.

A proximal end of an outlet block 1932 is coupled to fluid end 1912 such that outlet lumen 1924 is in fluid communication with outlet block lumen 1922 (could also be referred to as valve seat lumen 1922) of outlet block 1932. Outlet block 1932 is a modular component that includes outlet check valve 1934 and can be removably coupled to fluid end 1912 by mating threads 1984 on an exterior surface of outlet block 1932 with corresponding threads 1986 on an interior surface of fluid end 1912. This coupling can be secured by threading a fastener, such as a nut 1992 onto a portion of threads 1984 (or different threads on the exterior surface of outlet block 1932) such that the nut 1992 presses against fluid end 1912.

Outlet check valve 1934 includes a valve seat 1940, valve 1944, biasing spring 1948, and retaining member 1952. Valve seat 1940 can be press fitted or otherwise coupled onto an interior surface of outlet block 1932 and can have a shoulder 1926 configured to mate with a corresponding shoulder of valve 1944 such that, when so mated, fluid is prevented from flowing from outlet block lumen 1922 into discharge manifold 1908 (e.g., through hammer union fitting 1914). Valve 1944 includes tree 1980 that stabilizes and keeps valve 1944 centered in outlet block 1932. Tree 1980 protrudes from a first end of valve 1944 toward outlet lumen 1924 and includes a plurality of branches 1938, which may be equally-long, that press against the interior surface 1942 of valve seat 1940. The braches of tree 1980 are spaced apart such that fluid can flow past them and through valve seat 1940. A second end of valve 1944, spaced apart from the first end, is coupled to biasing spring 1948 at raised portion 1946 (e.g., by rotating a curved end of biasing spring 1948 around or into raised portion 1946). Biasing spring 1948 is compressed between and coupled at a first end 1950 to the second end of valve 1944 and at a second end 1954 to a first end of retaining member 1952 (e.g., by driving second end 1954 of biasing spring 1948 through hole 1958 of retaining member 1952 around central protrusion 1994 of retaining member 1952) such that biasing spring 1948 biases the shoulder of valve 1944 into mating contact with the corresponding shoulder of valve seat 1940 (i.e. the closed configuration). Retaining member 1952 maintains biasing spring 1948 in a compressed/biasing state by preventing movement of biasing spring 1948 away from valve 1944. Retaining member 1952 includes a plurality of spaced-apart, radially-extending arms 1956 that have shoulders 1962 at their radial ends that mate with a corresponding shoulder of outlet block 1932 so that retaining member 1952 (and the remainder of outlet check valve 1934) is held in place in outlet block 1932. The corresponding shoulder of outlet block 1932 that mates with shoulders 1962 of retaining member 1952 may be formed by positioning a ring 1964 between shoulders 1962 and outlet block 1932. The spaced-apart configuration of the radially-extending arms 1956 permits fluid to flow past them (e.g., into discharge manifold 1908, through hammer union fitting 1914). The above-described configuration of outlet check valve 1934 within outlet block 1932 allows fluid to flow from fluid end 1912 through outlet block 1932 into discharge manifold 1908, but prevents fluid from flowing from discharge manifold 1908 through outlet block 1932 into fluid end 1912.

A hammer union fitting 1914 having a hammer union fitting lumen 1918 can be coupled to a distal end 1966 of outlet block 1932 with a threaded connection 1996 (i.e., a friction connection that is created without requiring rotation of hammer union fitting 1914 or outlet block 1932) such that outlet block lumen 1922 is in fluid communication with hammer union fitting lumen 1918 when outlet check valve 1934 is in an open configuration (i.e., the shoulders of valve seat 1940 and valve 1944 are not mated). Alternatively or additionally, hammer union fitting 1914 can be coupled to the distal end 1966 of outlet block 1932 with a threaded connection. Hammer union fitting 1914 can be secured to outlet block 1932 by threading a fastener, such as a nut 1992 onto threads 1968 on the exterior surface of hammer union fitting 1914, such that the nut 1992 presses against outlet block 1932.

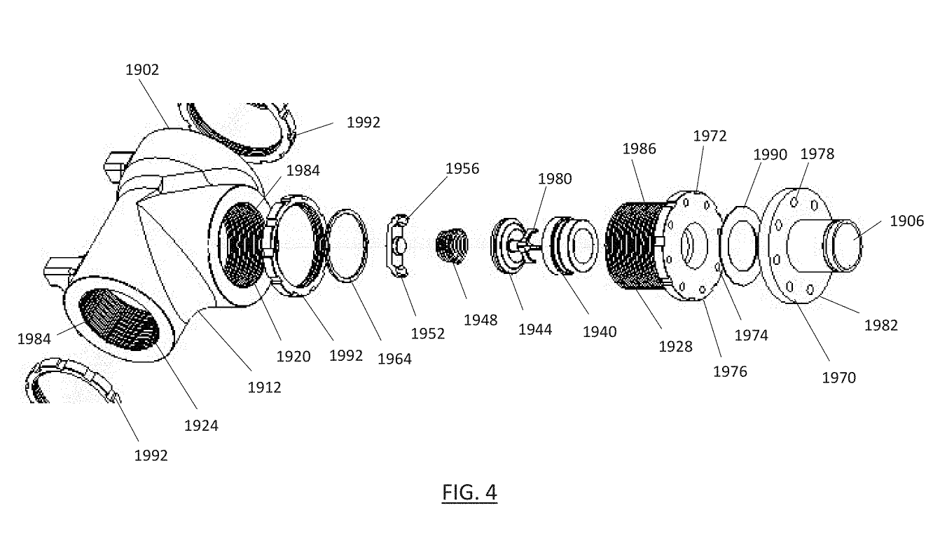

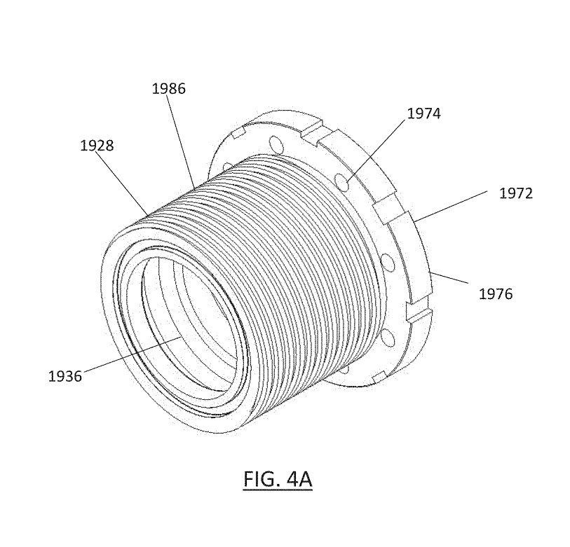

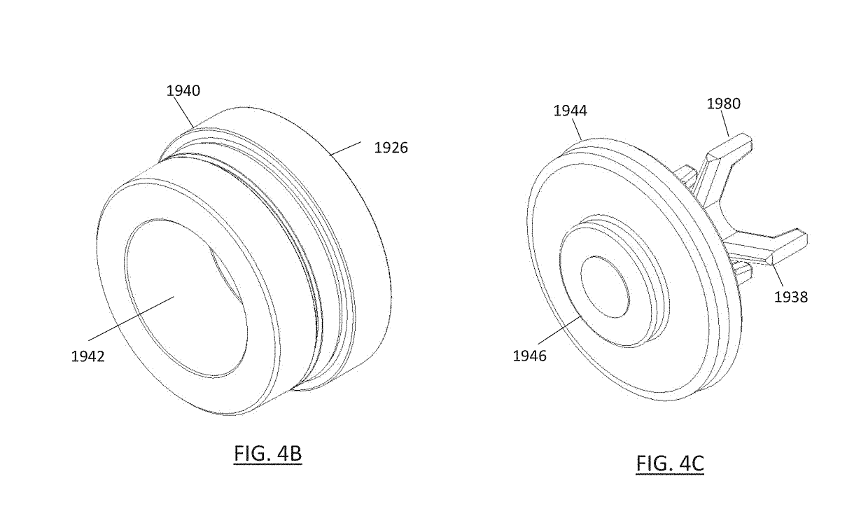

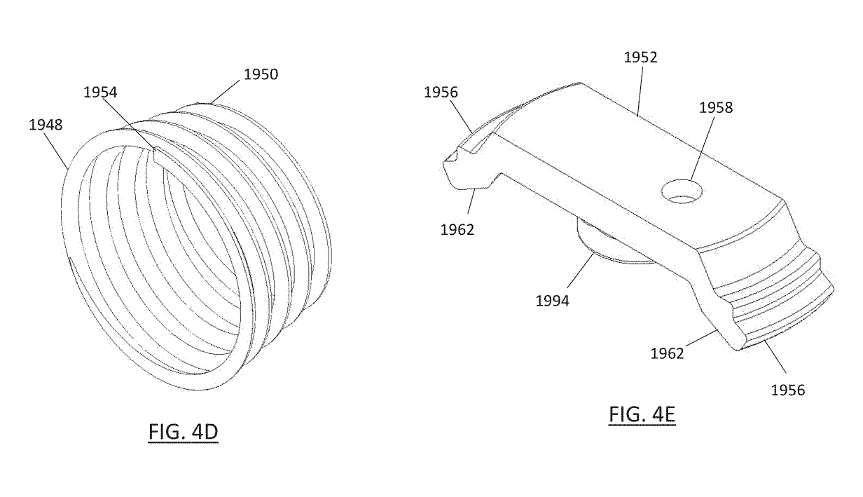

A proximal end of an inlet block 1928 is also coupled to fluid end 1912 such that inlet lumen 1920 is in fluid communication with inlet block lumen 1936 (could also be referred to as a valve seat lumen) of inlet block 1928 when the inlet check valve 1960 positioned within inlet block 1928 is in an open configuration. Inlet check valve 1960 includes the same components as outlet check valve 1934 (e.g., valve seat 1940, valve 1944, biasing spring 1948, and retaining member 1952) in substantially same configuration except that such components are arranged in an opposite order extending from inlet lumen 1920 of fluid end 1912, as shown in FIGS. 3 and 4. Accordingly, the shoulders 1962 on the radial ends of radially-extending arms 1956 of retaining member 1952 of inlet check valve 1960 can mate with a corresponding shoulder of fluid end 1912, such as that formed by ring 1964, or a corresponding shoulder of inlet block 1928. Additionally, tree 1980 of valve 1944 of inlet check valve 1960 protrudes away from inlet lumen 1920 of fluid end 1912. This configuration of inlet check valve 1960 within inlet block 1928 allows fluid to flow to fluid end 1912 through inlet block 1928 from, for example, inlet connection 1904 (e.g., via inlet manifold fitting 1970), but prevents fluid from flowing from fluid end 1912 through inlet block 1928 e.g., inlet connection 1904 (e.g., through inlet manifold fitting 1970).

Like outlet block 1932, inlet block 1928 is a modular component that can be removably coupled to fluid end 1912 by mating threads, such as threads 1986, on an exterior surface of inlet block 1928 with corresponding threads, such as threads 1984, on an interior surface of fluid end 1912. This coupling can be secured by threading a fastener, such as a nut 1992 in the same way as well. Inlet block 1932 can also be coupled at a distal end 1972 to inlet manifold fitting 1970 of inlet connection 1904, such that inlet block lumen 1936 is in fluid communication with inlet connection lumen 1906. Inlet block 1932 can be coupled at distal end 1972 to inlet manifold fitting 1970 through, for example, a flanged connection. For example, bolts can be secured through bolt holes 1974 of flange 1976 of inlet block 1928 and through corresponding bolt holes 1978 of flange 1982 of inlet manifold fitting 1970. A seal 1990 (e.g., a washer) may be disposed between flange 1976 and flange 1982 to ensure a fluid tight connection.

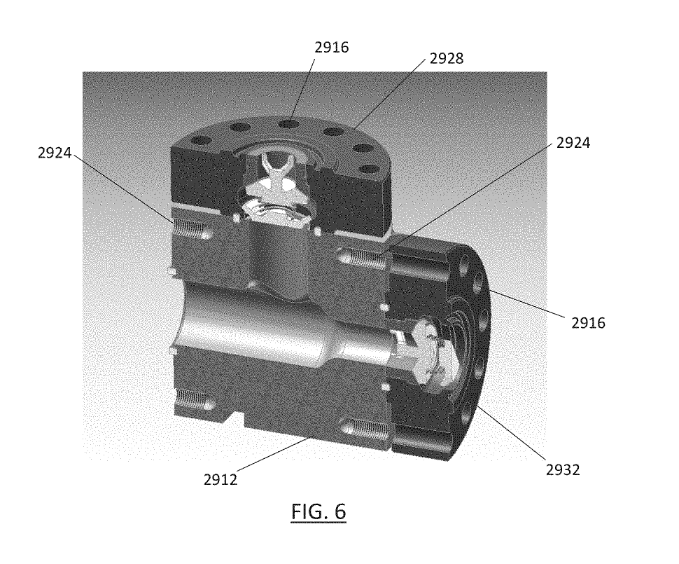

The inlet blocks and outlet blocks of a fluid end assembly can have additional configurations, as well. For example, FIG. 6 shows inlet block 2928 and outlet block 2932 coupled to a fluid end 2912. Like inlet block 1928 and outlet block 1932, inlet block 2928 and outlet block 2932 each include a check valve that is configured to be removed from fluid end 2912 when the block it is positioned within is decoupled from fluid end 2912. Unlike inlet block 1928 and outlet block 1932, however, inlet block 2928 and outlet block 2932 are configured to be coupled to fluid end 2912 with a bolted connection by securing a plurality of bolts through bolt holes 2916 in each of inlet block 2928 and outlet block 2932 and into corresponding bolt holes 2924 of fluid end 2912. Other components, such as a working fluid end cylinder may also be coupled to a fluid end, like fluid end 2912, with bolts through bolt holes 2924 in a similar manner.

The modular nature of inlet blocks 1928, 2928 and outlet blocks 1932, 2932 and the configuration of having check valves within the blocks, such as check valves 1960, 1934 secured within inlet block 1928 and outlet block 1932, respectfully, allows for easier and quicker access, replacement, and repair of check valves of a pumping assembly, such as check valves 1934, 1960. For example, if inlet check valve 1960 needs to be replaced or repaired, inlet manifold fitting 1970 can be decoupled (e.g., unbolted) from inlet block 1928, retaining nut 1992 may be unthreaded from inlet block 1928 such that inlet block 1928 is no longer secured to fluid end 1912, allowing inlet block 1928 (and inlet check valve 1960 disposed therein) to be removed (e.g., unthreaded) from fluid end 1912, so that inlet check valve 1960 can be accessed, replaced, and/or repaired. Thereafter, inlet block (including the replaced or repaired inlet check valve) may be recoupled (e.g. threaded) into fluid end 1912, secured with retaining nut 1992, and recoupled (e.g., bolted) back to inlet manifold fitting 1970 so that pumping operations may continue. Alternatively, the modular nature of inlet block 1928 allows inlet block 1928 itself to be replaced with another inlet block having a new/different check valve. In any of these methods, a check valve can be replaced/repaired in a relatively short span and with relative ease, even at a well site, such that pumping operations do not have to stop for long to replace/repair a check valve.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A pump fluid end assembly comprising:
a housing defining a pump port configured to be coupled to a pump, an inlet lumen in fluid communication with the pump port, and an outlet lumen in fluid communication with the pump port;
an inlet check valve disposed in the inlet lumen and configured to permit fluid to flow into the housing through the inlet lumen, and to prevent fluid from flowing out of the housing through the inlet lumen;
an outlet check valve disposed in the outlet lumen and configured to permit fluid to flow out of the housing through the outlet lumen, and to prevent fluid from flowing into the housing through the outlet lumen
an inlet block defining an inlet and removably coupled to the housing such that:
the inlet is in fluid communication with the inlet lumen of the housing; and
removal of the inlet block from the housing permits removal of the inlet check valve; and
an outlet block defining an outlet and removably coupled to the housing such that:
the outlet is in fluid communication with the outlet lumen of the housing; and
removal of the outlet block from the housing permits removal of the outlet check valve.

2. The fluid end assembly of claim 1, wherein at least one of the inlet block and outlet block is coupled to the housing with a threaded or bolted connection and held in place with a fastener.

3. The fluid end assembly of claim 1, wherein the inlet block further comprises a flange, the flange configured to couple to a fitting with a plurality of bolts.

4. The fluid end assembly of claim 1, where the inlet check valve comprises:
a first valve seat coupled to the inlet block, the first valve seat having a first valve seat shoulder and a first valve seat lumen configured to be in fluid communication with the inlet lumen of the housing when the inlet check valve is in an open configuration;
a first valve having a first valve shoulder and an end spaced apart from the first valve shoulder, the first valve configured to prevent fluid communication between first valve seat lumen and the inlet lumen of the housing when the inlet check valve is in a closed configuration, the closed configuration including mating the first valve shoulder with the first valve seat shoulder;
a first biasing spring having a first end and a second end spaced apart from the first end, the first end of the first biasing spring configured to be coupled to the end of the first valve and to bias the inlet check valve into the closed configuration; and
a first retainer plate have a first end and a first plurality of radially-extending arms spaced apart from the first end of the first retainer plate, the first plurality of radially-extending arms each having a shoulder at their radial ends, the first end of first retainer plate configured to be coupled to the second end of the first biasing spring, the first biasing spring further configured to bias the shoulders of the radial ends of the first plurality of radially-extending arms into mating contact with an inner shoulder of the inlet block or an inner shoulder of the housing;
wherein the first retainer plate does not block fluid communication between the inlet and the inlet lumen of the housing.

5. The fluid end assembly of claim 1, where the outlet check valve comprises:
a second valve seat coupled to the outlet block, the second valve seat having a second valve seat shoulder and a second valve seat lumen configured to be in fluid communication with the outlet lumen of the housing;
a second valve having a second valve shoulder and an end spaced apart from the second valve shoulder, the second valve configured to prevent fluid flow through the outlet check valve when the outlet check valve is in a closed configuration, the closed configuration including mating the second valve shoulder with the second valve seat shoulder;
a second biasing spring having a first end and a second end spaced apart from the first end, the first end of the second biasing spring configured to be coupled to the end of the second valve and to bias the outlet check valve into the closed configuration; and
a second retainer plate have a first end and a second plurality of radially-extending arms spaced apart from the first end of the second retainer plate, the second plurality of radially-extending arms each having a shoulder at their radial ends, the first end of second retainer plate configured to be coupled to the second end of the second biasing spring, the second biasing spring further configured to bias the shoulders of the radial ends of the second plurality of radially-extending arms into mating contact with an inner shoulder of the outlet block;
wherein the second retainer plate does not prevent fluid flow through the outlet.

6. The fluid end assembly of claim 5, further comprising:
a hammer union fitting having a fitting lumen, the hammer union fitting coupled to a first end of outlet block such that the fitting lumen is in fluid communication with the outlet, and the first end of the outlet block is spaced apart from the outlet lumen of the housing;
where the hammer union fitting has a proximal end coupled to the outlet block and a distal end with a hammer union connection configured to be coupled to an outlet manifold or conduit.

7. The fluid end assembly of claim 6, where the fitting is threaded into the outlet block.

8. The fluid end assembly of claim 1, further comprising a working fluid end cylinder coupled to the housing with an outlet of the working fluid end cylinder in fluid communication with the pump port.

9. (canceled)

10. (canceled)

11. A method of maintaining operation of a pump comprising:
positioning a pump assembly at a location where a pumping operation is to be performed, the pump assembly including a pump, a fluid end, and a first check valve; and
replacing the first check valve while the fluid end is connected to the pump.

12. The method of claim 11, where the pump assembly further includes a valve block, the first check valve positioned within the valve block and the valve block coupled to the fluid end, and where replacing the check valve comprises a first step of removing the valve block from the fluid end, a second step of replacing the first check valve in the valve block, and a third step of recoupling the valve block to the fluid end.

13. The method of claim 11, where the pump assembly further includes a first valve block, the first check valve positioned within the first valve block and the valve block coupled to the fluid end, and where replacing the first check valve comprises replacing the first valve block with a second valve block having a second check valve, the second check valve different from the first check valve.

14. The method of claim 11, further comprising:
positioning the first check valve in an inlet lumen of the fluid end, the first check valve configured to permit fluid to flow into the fluid end through the inlet lumen, and to prevent fluid from flowing out of the fluid end through the inlet lumen;
positioning a second check valve in an outlet lumen of the fluid end, the second check valve configured to permit fluid to flow out of the fluid end through the outlet lumen, and to prevent fluid from flowing into the fluid end through the outlet lumen;
removably coupling the inlet lumen of the fluid end to an inlet block defining an inlet, such that the inlet is in fluid communication with the inlet lumen of the fluid end; and removal of the inlet block from the housing permits removal of the first check valve; and
removably coupling the outlet lumen of the fluid end to an outlet block defining an outlet, such that the outlet is in fluid communication with the outlet lumen of the fluid end; and removal of the outlet block from the housing permits removal of the second check valve.

15. The method of claim 14, further comprising threading the inlet block and outlet block into the fluid end and securing the inlet block and outlet block in the fluid end with fastener.

16. The method of claim 14, further comprising coupling a fitting to a flange of the inlet block with a plurality of bolts, the flange on an end of the inlet block spaced apart from the inlet lumen.

17. The method of claim 14, further comprising assembling the first check valve by:
coupling a first valve seat to the inlet block, the first valve seat having a first valve seat shoulder and a first valve seat lumen configured to be in fluid communication with the inlet lumen of the fluid end when the first check valve is in an open configuration;
coupling a valve end of a first valve to a first end of a first biasing spring, the first valve having a first valve shoulder spaced apart from the valve end, the first valve configured to prevent fluid communication between first valve seat lumen and the inlet lumen of the housing when the first check valve is in a closed configuration, the closed configuration including mating the first valve shoulder with the first valve seat shoulder;
coupling a second end of the first biasing spring spaced apart from the first end of the first biasing spring to a first end of a first retainer plate, the first biasing spring configured to bias the first check valve into the closed configuration; and
biasing with the first biasing spring a plurality of shoulders at the radial ends of a first plurality of radially-extending arms of the first retainer plate into mating contact with an inner shoulder of the inlet block or an inner shoulder of the fluid end, the radially-extending arms of the first retainer plate spaced apart from the first end of the first retainer plate, wherein the first retainer plate is configured to retain the first biasing spring in a biasing position while permitting fluid communication between the inlet and the inlet lumen of the fluid end.

18. The method of claim 14, further comprising assembling the second check valve by:
coupling a second valve seat to the outlet block, the second valve seat having a second valve seat shoulder and a second valve seat lumen configured to be in fluid communication with the outlet lumen of the fluid end;
coupling a valve end of a second valve to a first end of a second biasing spring, the second valve having a second valve shoulder spaced apart from the valve end, the second valve configured to prevent fluid flow through the second check valve when the second check valve is in a closed configuration, the closed configuration including mating the second valve shoulder with the second valve seat shoulder;
coupling a second end of the second biasing spring spaced apart from the first end of the second biasing spring to a first end of a second retainer plate, the second biasing spring configured to bias the second check valve into the closed configuration; and
biasing with the second biasing spring a plurality of shoulders at the radial ends of a second plurality of radially-extending arms of the second retainer plate into mating contact with an inner shoulder of the outlet block, the radially-extending arms of the second retainer plate spaced apart from the first end of the second retainer plate, wherein the second retainer plate is configured to retain the second biasing spring in a biasing position while permitting fluid flow through the outlet.

19. The method of claim 18, further comprising:
coupling a hammer union fitting having a fitting lumen into a first end of the outlet block such that the fitting lumen is in fluid communication with the outlet, and the first end of the outlet block spaced apart from the outlet lumen of the fluid end; and
securing the fitting to the outlet block with a fastener.

20. (canceled)

21. The method of claim 12, further comprising coupling a working fluid end cylinder of the pump to the fluid end such that an outlet of the working fluid end cylinder is in fluid communication with the fluid end.

22-26. (canceled)

27. An assembly comprising:
a housing defining a fluid chamber; and
a valve block defining a lumen and removably coupled to the housing such that the lumen is in fluid communication with the fluid chamber of the housing and removal of the valve block from the housing permits removal of a check valve,
where the check valve is configured to permit fluid flow into or out of the fluid chamber of the housing when in an open configuration and to prevent fluid flow into or out of the fluid chamber of the housing when in a closed configuration.

28. The assembly of claim 27, wherein the valve block further comprises a flange, the flange configured to couple to a fitting with a plurality of bolts.

29. The assembly of claim 27, where the valve block is configured to be coupled to a manifold or conduit via a hammer union or threaded connection.

30. The assembly of claim 27, where the check valve comprises:
a valve seat coupled to the valve block, the valve seat having a valve seat shoulder and a valve seat lumen configured to be in fluid communication with the fluid chamber of the housing;
a valve having a valve shoulder and an end spaced apart from the valve shoulder, the valve configured to prevent fluid flow through the check valve when the check valve is in the closed configuration, the closed configuration including mating the valve shoulder with the valve seat shoulder;
a biasing spring having a first end and a second end spaced apart from the first end, the first end of the biasing spring configured to be coupled to the end of the valve and to bias the check valve into the closed configuration; and
a retainer plate have a first end and a plurality of radially-extending arms spaced apart from the end of the retainer plate, the plurality of radially-extending arms each having a shoulder at their radial ends, the first end of retainer plate configured to be coupled to the second end of the biasing spring, the biasing spring further configured to bias the shoulders of the radial ends of the plurality of radially-extending arms into mating contact with an inner shoulder of the valve block or an inner shoulder of the housing;
wherein the retainer plate does not prevent fluid flow through the valve block.
